(19) United States
(12) Patent Application Publication
(10) Pub. No.: US 2011/0201751 A1
(43) Pub. Date: Aug. 18, 2011

(54) Film Forming Silicone Emulsions

(76) Inventors: Yihan Liu, Midland, MI (US); Jefirey Rastello, Saginaw, MI (US)

(21) Appl. No.: 13/126,269

(22) PCT Filed: Oct. 30, 2009
(86) PCT No.: PCT/US2010/062714

§ 371 Date: Apr. 27, 2011

Related U.S. Application Data
(60) Provisional application No. 61/110,628, filed on Nov. 3, 2008.

(51) Int. Cl. C08L 83/06

(52) U.S. Cl. 524/837; 427/387

(57) ABSTRACT

Silicone emulsions are disclosed containing an organosiloxane reaction product from the emulsion polymerization of an alkoxysilane and an epoxy-functional alkoxysilane. The silicone emulsions provide transparent cured films upon drying.

### CROSS REFERENCE TO RELATED APPLICATIONS

This application claims the benefit of U.S. Patent Application No. 61/110,628 as filed on Nov. 3, 2008. U.S. Provisional Patent Application No. 61/110,628 is hereby incorporated by reference.

### TECHNICAL FIELD

This disclosure relates to silicone emulsions containing an organosiloxane reaction product from the emulsion polymerization of an alkoxysilane and an epoxy-functional alkoxysilane. The silicone emulsions provide transparent cured films upon drying.

### BACKGROUND

Silicone emulsions that dry to cured films are of interest in a variety of coating applications. Thus, there have been various attempts to prepare storage stable emulsions that upon drying form a cured silicone film. Very often to arrive at a cured film, many silicone emulsions require either the use of a condensation catalyst, such as an organic metal compound, and/or that the emulsion be stored at an alkaline pH to affect crosslinking for film formation. However, the films from these types of silicone emulsions are typically opaque.

Alternatively, it is known to employ the general method of using at least two emulsions, each containing a reactive component in the dispersed phase, and combining them together just prior to use, such that when combined and dried, the components react and thus cure into films. But this is less favored as compared to a one-component system due to inconvenience. Another approach is to add a film forming agent, such as polyvinyl alcohol, to a silicone emulsion to enhance film formation from a silicone emulsion.

Thus, a need exists to provide silicone emulsions, and in particular silicone resin emulsions, that dry to a cured silicone film without the need to add catalysts or film forming agents, or needing to adjust pH of the emulsion to high or low values.

The present inventors have unexpectedly discovered that silicone emulsions prepared by emulsion polymerization using certain combinations of an alkoxysilane or siloxane oligimers and an epoxy-functional alkoxysilane provide transparent cured silicone films upon drying. The present emulsions do not require a metal catalyst, do not require storage at a high or low pH, do not incorporate a film forming agent, and need not be combined with other components prior to use, to achieve cure. The present emulsions also provide transparent films upon drying a film of the emulsion.

### SUMMARY

This disclosure relates to an aqueous emulsion comprising a dispersed phase containing an organosiloxane reaction product from the emulsion polymerization of:

(i) an alkoxysilane having the formula R¹ₐSi(OR²)₄₋ₐ and

(ii) an epoxyfunctional alkoxysilane having the formula

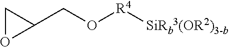

where R¹ is a hydrocarbon group having 1 to 18 carbon atoms,

R² is a hydrogen atom, an alkyl group containing 1-4 carbon atoms,
CH₃C(O)—, CH₃CH₂C(O)—, HOCH₂CH₂—, CH₃OCH₂CH₂—, or C₂H₅OCH₂CH₂—,

R³ is an alkyl group having 1 to 4 carbon atoms,

R⁴ is a divalent hydrocarbon linking group containing 2 to 6 carbon atoms,

the subscript a is zero to 3, b is zero to 2, with the proviso that a+b<4,

wherein the emulsion provides a transparent cured silicone film upon water removal.

### DETAILED DESCRIPTION

The present silicone emulsions may be prepared by the emulsion polymerization of (i) an alkoxysilane or siloxane oligimers and (ii) an epoxyfunctional alkoxysilane.

The alkoxysilane (i) has the formula R¹ₐSi(OR²)₄₋ₐ where the subscript a may vary from zero to 3, R¹ is a hydrocarbon group having 1 to 18 carbon atoms, alternatively R¹ is a hydrocarbon group having 2 to 8 carbon atoms; R² is a hydrogen atom, an alkyl group containing 1-4 carbon atoms, or one of the groups CH₃C(O)—, CH₃CH₂C(O)—, HOCH₂CH₂—, CH₃OCH₂CH₂—, or C₂H₅OCH₂CH₂—. R¹ may be an alkyl group such as ethyl, propyl, butyl, pentyl, or hexyl, a fluoro alkyl group, an alkenyl group such as vinyl, or an aryl group such as a phenyl group. Alternatively R¹ is propyl. R² may be methyl, ethyl, propyl, or butyl. Alternatively R² is methyl.

Alkylalkoxysilanes having the formula R¹ₐSi(OR²)₄₋ₐ are known, and many are commercially available, such as those listed below from Dow Corning Corporation (Midland Mich.); methyltrimethoxysilane (Dow Corning® Z-6070), methyltriethoxysilane (Dow Corning® Z-6370), ethyltrimethoxysilane (Dow Corning® Z-6321), propyltrimethoxysilane (Dow Corning® Z-6264), propyltriethoxysilane (Dow Corning® Z-6535), isobutyltrimethoxysilane (Dow Corning® Z-2306), isobuyltriethyoxysilane (Dow Corning®Z -6403), isobutyltriacetoxysilane, n-hexyltrimethoxysilane (Dow Corning® Z 6582), n-octyltrimethoxysilane (Dow Corning® Z-6665), n-octyltriethoxysilane (Dow Corning® Z-6341), i-octyltrimethoxysilane (Dow Corning® Z-6672), i-octyltriethoxysilane, phenyltrimethoxysilane (Dow Corning® Z-6124), phenyltriethoxysilane (Dow Corning® Z-9805), dimethyldimethoxysilane (Dow Corning® Z 6194), dimethyldiethoxysilane, methylphenyldimethoxysilane, methylphenyldiethoxysilane, dibutyldimethoxysilane, vinyltrimethoxysilane (Dow Corning® Z-6300), tetraethoxysilane (Dow Corning® Z-6697), vinyltriethoxysilane (Dow Corning® Z-6518), Vinyl tris(methoxyethoxy)silane (Dow Corning® Z 6172), 3,3,3-trifluoropropyltrimethoxysilane, or 6,6,6 trifluorohexyltrimethoxysilane.

The alkoxysilane selected as component (i) may be a single alkoxysilane, as described above, or any combination or mixture of such alkoxysilanes. The alkoxysilane may also contain additional alkoxysilanes not conforming to the formula described above. For example, the additional alkoxysilane may be an organofunctional silane such as 3-methacryloxypropyltrimethoxysilane (Dow Corning® Z 6030), or chloropropyltrimethoxysilane (Dow Corning® Z 6076), or 3-chloropropyltriethoxysilane (Dow Corning® Z 6376).

The epoxyfunctional alkoxysilane (ii) may have the formula

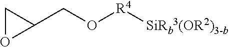

where R² is an alkyl group as defined above, R³ is an alkyl group containing 1-4 carbon atoms, and R⁴ is a divalent hydrocarbon linking group containing 2 to 6 carbon atoms, and the subscript b may vary from 0 to 2. Typically, R⁴ is propylene and the subscript b is 0.

Epoxyfunctional alkoxysilane having the formula above are known, and many are commercially available, such as Z-6040 (Dow Corning Corp., Midland Mich.) 3-glycidoxypropyltrimethoxysilane; Z-6042 3-glycidoxypropyltriethoxysilane; (3-glycidoxypropyl)methyldimethoxysilane (Gelest); (3-glycidoxypropyl)methyldiethoxysilane (Gelest); (3-glycidoxypropyl)dimethylethoxysilane (Gelest).

The alkoxysilane and epoxyfunctional alkoxysilane are chosen such that the combination of subscripts a and b in the respective formulas is less than 4. This selection ensures that at least a portion of the alkoxysilane or epoxyfunctional alkoxysilane selected provides some T or Q siloxy units in the organosiloxane reaction product thereby providing crosslinking sites for formation of elastomeric or resinous materials.

The amounts of components (i) and (ii) used to prepare the present silicone emulsions may vary, provided that the amounts used provide a silicone emulsion that upon drying yields a transparent cured silicone film. Alternatively, the amounts of components (i) and (ii) are selected such that the mole ratio of (i)/(ii) varies from 98:2 to 50:50, alternatively from 90:10 to 65:35.

Additional silane monomers, or more than one type of monomer can be used in the preparation of the present emulsions. The silane monomers may produce copolymers by either sequential addition of an appropriate amount of each monomer or by addition of a mixture of the different monomers to the catalyzed aqueous surfactant mixture. A silane partial hydrolysis-condensation product, such as an oligomer, can also be used as the starting material provided that the solubility in the aqueous medium is not unduly decreased. The total amount of monomer incorporated is not critical, but is typically between 10 to 50 percent based on the combined weight of the water, surfactant, catalyst and monomer, the appropriate level depending on the nature of the monomer and the particle sized targeted. Monomer levels at the high end are achievable with simultaneous removal of the alcohol formed from hydrolysis of alkoxysilane. Monomer levels less than 10 percent are possible but results in a final emulsion with a low solid content, and thus may not be economical. One can always dilute the emulsion post-made with water to arrive at a diluted composition, or alternatively, strip out some of the water to achieve a higher active content.

The present silicone emulsions may be prepared by any emulsion polymerization technique known, such as those described in U.S. Pat. No. 2,891,920, U.S. Pat. No. 3,294,725, and U.S. Pat. No. 6,316,541. Alternatively, the present silicone emulsions are prepared according to the methods taught in WO2006/016968, which is hereby incorporated by reference in its entirety for its teaching of emulsion polymerization using alkoxysilane monomers. The process as taught in WO2006/016968 involves first mixing water, surfactant and catalyst in a reaction vessel and heating to reaction temperature followed by monomer feed over a period of time. The monomer reacts in the aqueous medium forming polymer particles stabilized by the surfactants. Once desired molecular weight is reached, the reaction is terminated by deactivating the catalyst. Additional water can then be added to achieve certain solid content, additional surfactant can also be added, if needed, to achieve dilutional stability. Other additives such as biocide can be optionally added.

Sufficient mixing of the water, surfactant and catalyst prior to addition of the monomer is important; so is constant agitation during and following monomer feed until a stable emulsion is formed. High speed shear is not required. Emulsification of monomer prior to feed is not necessary. Monomer addition should be at a rate less than 20 moles per liter of water per hour, preferably less than 10 moles per liter of water per hour; the exact rate depends on the type of monomer, catalyst level and reaction temperature, and can be determined as appropriate by one skilled in the art.

To reach a narrow particle size distribution of the final emulsion, typically the temperature of the aqueous mixture containing the surfactant and catalyst is stabilized and kept relatively constant during and following monomer feed until all monomers are consumed, though this is not necessary to arrive at a film forming emulsion. Polymerization reaction temperatures useful in the process of this invention are typically above the freezing point but below the boiling point of water under the operating pressure, which is normally at atmosphere. The preferred temperature range is 20-95° C.

The polymerization reaction is carried out in the aqueous medium containing the surfactant and catalyzed by siloxane condensation catalyst. Condensation polymerization catalysts known in the art include strong acids such as substituted benzenesulfonic acids, aliphatic sulfonic acids, hydrochloric acid and sulfuric acid, and strong bases such as quaternary ammonium hydroxides and alkali metal hydroxides. Some ionic surfactants, such as alkylbenzenesulfonic acid, can additionally function as the catalyst. Usually an acid is used to catalyze polymerization in an anionic stabilized emulsion and a base, in a cationic system. Nonionically stabilized emulsions can use either an acid or base catalyst. The catalyst of the instant invention is present in the aqueous reaction medium usually at levels of 10⁻⁴ to 1 M. In some instances, when an amine containing alkoxysilane is used as one of the monomers, the amine functionality can catalyze the reaction and no additional catalyst is needed. Acid catalyzed anionic or nonionic surfactant stabilized system is found to be more effective in arriving at transparent film forming emulsions of the present invention.

Reaction times are generally less than 24 hours and typically less than 8 hours from the start of the monomer feed. When the polymer reaches the desired molecular weight, it is preferable to terminate the reaction by neutralizing the catalyst using an equal or slightly greater stoichiometric amount of acid or base for base catalyzed or acid catalyzed systems, respectively. When an amine-containing alkoxysilane is used without additional catalyst, an acid can be used to neutralize the reaction. Acids that can be used to neutralize the reaction include strong or weak acids such as hydrochloric acid, sulfuric acid and acetic acid. Bases that can be used to neutralize the reaction include strong or weak bases such as quaternary ammonium hydroxides, alkali metal hydroxides, triethanolamine and sodium carbonate. It is preferred to neutralize with sufficient quantities of acid or base such that the resulting emulsion has a pH equal to or slightly less than 7 when a cationic surfactant is present and a pH equal to or slightly greater than 7 when an anionic surfactant is present.

When alkoxysilane is used as a monomer, the alcohol formed as a by-product from the hydrolysis can be removed by either simultaneous distillation during polymerization or post stripping after the emulsion is made.

The reaction medium must comprise one or more surfactants to stabilize the silicone polymer particles formed. It is found that while anionic or cationic or nonionic surfactant can be used alone or in various combinations to make a stable emulsion from the monomers of the present invention and by the current method, anionic or anionic-plus-nonionic surfactants are particularly effective in achieving an emulsion which dries to an optically clear film.

Suitable anionic surfactants include, but are not limited to, sulfonic acids and their salts including alkyl, alkylaryl, alkylnapthalene, and alkyldiphenylether sulfonic acids and their salts having at least 6 carbon atoms in the alkyl substituent, such as dodecylbenzensulfonic acid and its sodium or amine salt; alkyl sulfates having at least 6 carbon atoms in the alkyl substituent such as sodium lauryl sulfate; the sulfate esters of polyoxyethylene monoalkyl ethers; long chain carboxylic acid surfactants and their salts such as lauric acid, steric acid, oleic acid and their alkali metal and amine salts. Certain anionic surfactants, such as dodecylbenzene sulfonic acid act both as a surfactant and a catalyst, in which case additional acid catalyst may or may not be needed. Alternatively, an anionic surfactant plus a strong acid catalyst such as sulfuric acid may be used. Anionic surfactants commercially available and useful in the instant invention include, but are not limited to, dodecylbenzenesulfonic acid sold under the name Bio-Soft® S-100 or S-101 and its triethanolamine salt sold under the name Bio-Soft® N-300 by Stepan Co.

Suitable cationic surfactants include, but are not limited to, fatty acid amines and amides and their salts and derivatives such as aliphatic fatty amines and their derivatives; and quaternary ammonium compounds such as alkyl trimethylammonium and dialkyldimethylammonium halides or acetates or hydroxides having at least 8 carbon atoms in each alkyl substituent. Cationic surfactants commercially available and can be used include Arquad T27W, Arquad 16-29, by Akzo Nobel, and Ammonyx Cetac-30 by Stepan.

Nonionic surfactants useful in the instant invention are those that have a hydrophilic-lipophilic balance (HLB) number between 10 and 20. When a nonionic surfactant with an HLB of less than 10 is used, it is preferred that it be used in combination with another nonionic surfactant with an HLB greater than 10 or another ionic surfactant. Suitable nonionic surfactants include, but are not limited to, polyoxyethylene alkyl ethers, polyoxyethylene alkyl phenyl ethers, polyoxyethylene fatty acid esters, sorbitan fatty acid esters and polyoxyethylene sorbitan fatty acid esters. Nonionic surfactants commercially available and useful in the instant invention include, but are not limited to, 2,6,8-trimethyl-4-nonyl polyoxyethylene ethers sold under the name Tergitol® TMN-6 and Tergitol® TMN-10, C11-15 secondary alkyl polyoxyethylene ethers sold under the name Tergitol® 15-S-7, Tergitol® 15-S-9, Tergitol® 15-S-15, Tergitol® 15-S-30 and Tergitol® 15-S-40, all by Dow Chemical; and the Lutensol® alcohol ethoxylates from BASF.

The combined total amount of surfactants useful in the instant invention are 0.01 to 50 percent based on the weight of the silicone polymer formed, the exact amount depending on the particle size targeted. Typically less than 20 percent based on the silicone polymer formed is used.

The silicone emulsions contain an organosiloxane reaction product from the emulsion polymerization. The organosiloxane reaction product made by the present method may be either homo- or co-polymers comprising 0-100 mol % tri-functional siloxane units of RSiO_{3/2} (T), 0-95 mol % di-functional units of R₂SiO_{2/2} (D), 0-50 mol % tetra-functional units of SiO_{4/2} (O), and 0-50 mol % mono-functional units of R₃SiO_{1/2} (M), where R is the same or different monovalent hydrocarbon or functional substituted hydrocarbon groups, some of which may be halogenated, and at least one R group in the polymer contains an epoxy group or its hydrolytic product.

In one embodiment, the organosiloxane reaction product comprises an organopolysiloxane resin having an average empirical formula

R¹ₓR⁵_{y}Si(OZ)_{z}(O)_{[4-x-y-4]/2}

where
R¹ is an alkyl group or a mixture of alkyl groups having 1-18 carbons, alternatively 2 to 6 carbon atoms, as described above,
R⁵ is an epoxy or diol functional organic group,
Z is hydrogen or an alkyl group having 1-4 carbon atoms,
x has a value from 0.75 to 1.9,
y has a value from 0.02 to 0.5,
z has a value from 0.05 to 2.0.
   The epoxy or diol functional organic group R⁵ may have the formula —R⁴—CH₂CH(OH)CH₂OH or be 3-glycidoxypropyl.

The present emulsions are typically stable on standing for months to years. Generally when an emulsion is applied on a substrate to let water evaporate, any type of film is possible ranging from elastomeric to a brittle solid. Useful films according to the present invention are those that are coherent and cured into a solid or semi-solid but not powdery; particularly desirable are those that are also optically transparent.

The present emulsions can be used as is or diluted with water, or as an additive into a formulation to treat material on the surface to impart various desirable properties such as protection, aesthetics, shine, smooth feel, and so on. So the present emulsion is useful as a treating agent for surface polish, fabrics, leather, metals, glasses, plastics, human nail and hair, and building materials, and thus has applications in cosmetics and personal care, textiles, household care, auto care and coatings. The present emulsion can also be used as a binder.

### EXAMPLES

These examples are intended to illustrate the invention to one of ordinary skill in the art and should not be interpreted as limiting the scope of the invention set forth in the claims. All measurements and experiments were conducted at 23° C., unless indicated otherwise.

### Example 1

To a 500 ml three-neck round bottom flask was added 196 g of water, 4.49 g of Bio-Soft® S-101, and 0.6 g of Brij® 35L (72% active in water). The content of the flask was stirred using a Teflon paddle stirrer with a diameter of 6 cm which was attached to a glass rod fitted to the flask at a speed of 300 rpm while being heated to 50° C. A mixture of 86.4 g of propyltrimethoxysilane and 9.7 g of 3-glycidyloxypropyl-trimethoxysilane was added to the flask over a period of 115 minutes at a constant rate. The mixture was held at 50° C. for an additional 35 minutes after which 2.62 g of an 85% triethanolamine aqueous solution was added dropwise. The final emulsion recovered was translucent. The particle size distribution was monomodal, as measured using a Nanotrac™ 150 particle analyzer (made by Microtrac Inc.) in the volume mode, with a median diameter at 12 nanometers. ²⁹Si NMR indicated a resin structure of T²_{0.36}(OZ)T³_{0.64} or alternatively expressed as R¹_{0.9}R⁵_{0.1}Si(OZ)_{0.36}(O)_{1.32} where R¹═CH₃CH₂CH₂— and R⁵═CH₂OHCHOHCH₂OCH₂CH₂CH₂—, Z═H or CH₃, mostly H. The emulsion was stable for at least a year.

Two grams of the above emulsion was placed in a 6 cm-diameter polystyrene Petri-dish and was allowed to dry in air under the ambient condition for 24 hrs. A transparent, solid (cured) film resulted with no crack. The film was slightly tacky upon touch by the fingers.

### Example 2

Following the same procedure as in Example 1, the following quantities of materials were used instead: 194 g of water, 1.67 g of Bio-Soft® S-101, 5.14 g of Brij® 35L, 86.1 g of propyltrimethoxysilane, 9.4 g of 3-glycidyloxypropyltrimethoxysilane, and 0.91 g of a 85% triethanolamine aqueous solution. The mixture of silanes was added to the flask over a period of 129 minutes and the mixture was held at 50° C. for an additional 141 minutes. The final emulsion was milky white with a monomodal particle size distribution centered around a median diameter of 154 nanometers. The emulsion was stable for at least a year. A film resulted from this emulsion dried in a similar manner as in Example 1 was translucent with a slight haze, cured but slightly tacky.

### Example 3

Following the same procedure as in Example 1, the following quantities of materials were used instead: 196 g of water, 4.5 g of Bio-Soft® S-101, 0.6 g of Brij® 35L, 77.4 g of propyltrimethoxysilane, 18.6 g of 3-glycidyloxypropyltrimethoxysilane, and 2.6 g of a 85% triethanolamine aqueous solution. The mixture of silanes was added to the flask over a period of 120 minutes and the mixture was held at 50° C. for an additional 30 minutes. The resultant emulsion was whitish translucent with a monomodal particle size distribution centered around a median diameter of 86 nanometers. The methanol in the emulsion was removed in a rotavap to yield an emulsion with a solid content of 34 wt %. ²⁹Si NMR indicated a resin structure of T²_{0.35}(OZ)T³_{0.65} or alternatively expressed as R¹_{0.86}R⁵_{0.14}Si(OZ)_{0.35}(O)_{1.33} where R¹═CH₃CH₂CH₂— and R⁵═CH₂OHCHOHCH₂OCH₂CH₂CH₂—, Z═H or CH₃, mostly H. The emulsion was stable for at least a year. Films resulted from both the emulsions before and after methanol removal and dried in a similar manner as in Example 1 were transparent, cured, non-tacky and with no crack.

### Example 4

Following the same procedure as in Example 1, the following quantities of materials were used instead: 196 g of water, 1.65 g of Bio-Soft® S-101, 5.08 g of Brij® 35L (72% active in water), 77.4 g of propyltrimethoxysilane, 18.9 g of 3-glycidyloxypropyltrimethoxysilane, and 0.94 g of a 85% triethanolamine aqueous solution. The mixture of silanes was added to the flask over a period of 136 minutes and the mixture was held at 50° C. for an additional 134 minutes. The resultant emulsion was milky white with a mono-modal particle size distribution centered around a median diameter of 260 nanometers. The methanol in the emulsion was removed in a rotavap to yield an emulsion with a solid content of 32 wt %. The emulsion was stable for at least a year. Films resulted from both the emulsions before and after methanol removal and dried in a similar manner as in Example 1 were transparent, cured, non-tacky and with no crack.

### Example 5

To a 3 liter three-neck round bottom flask was added 1598 g of water, 29.79 g of Bio-Soft® S-101, and 21.67 g of Brij35L (72% active in water). The content of the flask was stirred using a Teflon paddle stirrer with a diameter of 11 cm which was attached to a glass rod fitted to the flask at a speed of 300 rpm while being heated to 90° C. The flask was fitted with a Dean Starke trap and was wrapped around with a thermal insulating mat. A mixture of 540 g of propyltrimethoxysilane and 195 g of 3-glycidyloxypropyltrimethoxysilane was added to the flask over a period of 120 minutes at a constant rate. The mixture was held at 90° C. for an additional 30 minutes after which 18.1 g of an 85% triethanolamine aqueous solution was added slowly. Meanwhile a total of 115 g of volatiles was removed from the Dean Starke trap.

The resulted emulsion was milky white with a monomodal particle size distribution having a median diameter of 124 nanometers. The residual methanol in the emulsion was further removed in a rotavap during which some water was back added to yield a final emulsion with a solid content of 27 wt %. Films resulted from both the emulsions before and after residual methanol removal and dried in a similar manner as in Example 1 were transparent, cured, non-tacky and with no crack.

### Example 6

To a 500 ml three-neck round bottom flask was added 233.6 g of water, 4.22 g of Soft® S-101, and 3.22 g of Brij® 35L (72% active in water). The content of the flask was stirred using a Teflon paddle stirrer with a diameter of 6 cm which was attached to a glass rod fitted to the flask at a speed of 300 rpm while being heated to 90° C. The flask was fitted with a Dean Starke trap and was wrapped around with a thermal insulating mat. A mixture of 78.8 g of propyltrimethoxysilane and 28.4 g of 3-glycidyloxypropyltrimethoxysilane was added to the flask over a period of 106 minutes at a constant rate. The mixture was held at 90° C. for an additional 44 minutes after which 2.5 g of a 85% triethanolamine aqueous solution was added slowly. Meanwhile a total of 31.5 g of volatiles was removed from the Dean Starke trap.

The resulted emulsion was milky white with a monomodal particle size distribution centered around a median diameter of 156 nanometers. The emulsion was stable for at least a year. A film resulted from this emulsion dried in a similar manner as in Example 1 was transparent, cured, non-tacky and with no crack.

### Example 7

Following the same procedure as in Example 6, the following quantities of materials were used instead: 196.5 g of water, 4.5 g of Bio-Soft® S-101, 0.6 g of Brij® 35L, 72 g of propyltrimethoxysilane, 24 g of 3-glycidyloxypropyltrimethoxysilane, and 2.5 g of a 85% triethanolamine aqueous solution. The mixture of silanes was added to the flask over a period of 120 minutes and the reaction was neutralized as soon as all the monomers were metered in. A total of 49 g volatiles were removed from the Deans trap. The resultant emulsion was milky white with a monomodal particle size distribution centered around a median diameter of 96 nanometers. The emulsion was stable for at least a year. Films resulted from this emulsion dried in a similar manner as in Example 1 was transparent, cured, non-tacky and with some cracks.

### Example 8

Following the same procedure as in Example 6, the following quantities of materials were used instead: 197 g of water, 4.52 g of Bio-Soft® S-101, 64.5 g of propyltrimethoxysilane, 31.5 g of 3-glycidyloxypropyltrimethoxysilane, and 2.48 g of a 85% triethanolamine aqueous solution. The mixture of silanes was added to the flask over a period of 68 minutes and the mixture was held at 90° C. for an additional 10 minutes. A total of 14.2 g volatiles were removed from the Deans trap. The resultant emulsion was milky white with a monomodal particle size distribution centered around a median diameter of 218 nanometers. The emulsion was stable for at least a year. Films resulted from this emulsion dried in a similar manner as in Example 1 was transparent, cured, non-tacky and with no crack.

### Example 9

Following the same procedure as in Example 6, the following quantities of materials were instead used: 197 g of water, 4.50 g of Bio-Soft® S-101, 54.0 g of propyltrimethoxysilane, 42.1 g of 3-glycidyloxypropyltrimethoxysilane, and 2.42 g of a 85% triethanolamine aqueous solution. The mixture of silanes was added to the flask over a period of 99 minutes and the mixture was held at 90° C. for an additional 21 minutes. A total of 17.4 g volatiles were removed from the Deans trap. The resultant emulsion was milky white with a monomodal particle size distribution centered around a median diameter of 120 nanometers. ²⁹Si NMR indicated a resin structure of T²_{0.18}(OZ)T³_{0.82} or alternatively expressed as R¹_{0.65}R⁵_{0.35}Si(OZ)_{0.18}(O)_{1.41} where R¹═CH₃CH₂CH₂— and R⁵═CH₂OHCHOHCH₂OCH₂CH₂CH₂—, Z═H or CH₃, mostly H. The emulsion was stable for at least a year. Films resulted from this emulsion dried in a similar manner as in Example 1 was transparent, cured, non-tacky and with no crack.

### Example 10

To a 500 ml three-neck round bottom flask was added 214.5 g of water, 4.50 g of dodecylbenzenesulfonic acid, and 0.60 g of Brij® 35L. The content of the flask was stirred using a Teflon paddle stirrer with a diameter of 6 cm which was attached to a glass rod fitted to the flask at a speed of 300 rpm while being heated to 90° C. The flask was fitted with a Dean Starke trap and was wrapped around with a thermal insulating mat. A mixture of 23.8 g of propyltrimethoxysilane; 31.9 g of dimethyldimethoxysilane and 16.6 g of 3-glycidyloxypropyltrimethoxysilane was added to the flask over a period of 120 minutes at a constant rate. The mixture was held at 90° C. for an additional hour after which 2.53 g of a 85% triethanolamine aqueous solution was added slowly. Less than 5 g of volatiles were removed from the Deans trap.

The resulted emulsion was milky white with a monomodal particle size distribution centered around a median diameter of 84 nanometers. The emulsion was stable for at least six months. A film resulted from this emulsion dried in a similar manner as in Example 1 was transparent, cured, soft and rubbery.

### Example 11

Following the same procedure as in Example 10, the following quantities of materials were used instead: 217.3 g of water, 4.50 g of Bio-Soft® S-101, 0.6 g of Brij® 35L, 12.7 g of propyltrimethoxysilane; 44.15 g of dimethyldimethoxysilane, 18.5 g of 3-glycidyloxypropyltrimethoxysilane, and 2.62 g of a 85% triethanolamine aqueous solution. The mixture of silanes was added to the flask over a period of 125 minutes and the mixture was held at 90° C. for an additional 55 minutes. A total of 17 g volatiles were removed from the Deans trap. The resultant emulsion was milky white with a monomodal particle size distribution centered around a median diameter of 84 nanometers. ²⁹Si NMR indicated a resin structure of D¹_{0.047}(OZ) D²_{0.64}T²_{0.026}(OZ)T³_{0.29} or alternatively expressed as R¹_{1.537}R⁵_{0.15}Si(OZ)_{0.073}(O)_{1.12} where R¹═(CH₃)_{1.37}(C₃H₇)_{0.167} and R⁵═CH₂OHCHOHCH₂OCH₂CH₂CH₂—, Z═H or CH₃, mostly H. The emulsion was stable for at least six months. A film resulted from this emulsion dried in a similar manner as in Example 1 was transparent, cured, soft and rubbery.

### Example 12

To a 500 ml three-neck round bottom flask was added 182.5 g of water, 15.67 g of Arquad® 16-29, 4.41 g of Tergitol® 15-S-40 (70% actives in water), and 0.32 g of a 30 wt % sodium hydroxide aqueous solution. The content of the flask was stirred using a Teflon paddle stirrer with a diameter of 6 cm which was attached to a glass rod fitted to the flask at a speed of 300 rpm while being heated to 90° C. The flask was fitted with a Dean Starke trap and was wrapped around with a thermal insulating mat. A mixture of 86.7 g of propyltrimethoxysilane and 9.75 g of 3-glycidyloxypropyltrimethoxysilane was added to the flask over a period of 120 minutes at a constant rate. The mixture was held at 90° C. for an additional 30 minutes after which 1.35 g of a 10% acetic acid in water was added slowly. A total of 30.75 g volatiles were removed from the Deans trap.

The resulted emulsion was translucent with a slight bluish haze. The particle size distribution was monomodal centered around a median diameter of 11 nanometers. The emulsion was stable for at least six months. A film resulted from this emulsion dried in a similar manner as in Example 1 was cloudy white, cured but cracked.

### Comparative Example 1

3-glycidyloxypropyltrimethoxysilane in Example 1 was replaced by the same amount of propyltrimethoxysilane while all other ingredients as well as the procedure were kept the same. This resulted in a cloudy emulsion with a wide particle size distribution centered around 50 nanometers. Two grams of this emulsion was dried in a Petri dish in the same manner as in Example 1, resulting in a hazy gum-like viscous liquid.

### Comparative Example 2

3-glycidyloxypropyltrimethoxysilane in Example 11 was replaced by the same amount of propyltrimethoxysilane while all other ingredients as well as the procedure were kept the same. This resulted in a cloudy emulsion with a wide particle size distribution centered around 65 nanometers. Two grams of this emulsion was dried in a Petri dish in the same manner as in Example 1, resulting in a cloudy viscous liquid, sticky to the finger touch.

### Comparative Example 3

3-glycidyloxypropyltrimethoxysilane in Example 12 was replaced by the same amount of propyltrimethoxysilane while all other ingredients as well as the procedure were kept the same. This resulted in a translucent emulsion with a monomodal particle size distribution centered around 7 nanometers. Two grams of this emulsion was dried in a Petri dish in the same manner as in Example 1, resulting in a hazy solid film which was smooth and non-tacky but brittle.

1. An aqueous emulsion comprising a dispersed phase containing an organosiloxane reaction product from the emulsion polymerization of:
(i) an alkoxysilane having the formula R¹ₐSi(OR²)₄₋ₐ and
(ii) an epoxyfunctional alkoxysilane having the formula 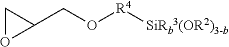
where R¹ is a hydrocarbon group having 1 to 18 carbon atoms,
R² is a hydrogen atom, an alkyl group containing 1-4 carbon atoms,
CH₃C(O)—, CH₃CH₂C(O)—, HOCH₂CH₂—, CH₃OCH₂CH₂—, or C₂H₅OCH₂CH₂—,
R³ is an alkyl group having 1 to 4 carbon atoms,
R⁴ is a divalent hydrocarbon linking group containing 2 to 6 carbon atoms,
the subscript a is zero to 3, b is zero to 2, with the proviso that a+b<4,
wherein the emulsion provides a transparent cured silicone film upon water removal.

2. The aqueous emulsion of claim 1 wherein the mole ratio of (i)/(ii) varies from 98:2 to 50:50.

3. The aqueous emulsion of claim 1 wherein
R¹ is propyl, R² is methyl, and R⁴ is propylene.

4. The aqueous emulsion of claim 3 wherein the subscript a is 1 and b is zero.

5. The aqueous emulsion of claim 1 wherein the organosiloxane reaction product comprises an organopolysiloxane resin having an average empirical formula
R¹ₓR⁵_{y}Si(OZ)_{z}(O)_{[4-x-y-z]/2}
where R¹ is an alkyl group or a mixture of alkyl groups having 1 to 18 carbon atoms,
R⁵ is an epoxy or diol functional organic group,
Z is hydrogen or an alkyl group having 1-4 carbon atoms,
x has a value from 0.75 to 1.9,
y has a value from 0.02 to 0.5,
z has a value from 0.05 to 2.0.

6. A method of making a transparent cured silicone film comprising coating a surface with the emulsion composition of claim 1 and allowing the emulsion to dry.

7. The cured silicone film prepared by the method of claim 6.
